(19) United States
(12) Patent Application Publication
(10) Pub. No.: US 2012/0039573 A1
(43) Pub. Date: Feb. 16, 2012

(54) Connector

(76) Inventors: Thomas Moriarty, Cork (IE); Michael O'Gorman, County Cork (IE)

(21) Appl. No.: 13/265,790

(22) PCT Filed: Apr. 27, 2010
(86) PCT No.: PCT/IE10/00029

§ 371 Date: Oct. 21, 2011

(30) Foreign Application Priority Data
Apr. 28, 2009 (IE) 2009/0336
May 20, 2009 (IE) 2009/0385

(51) Int. Cl. G02B 6/36

(52) U.S. Cl. 385/88

(57) ABSTRACT

A connector (20) has one part (22) which provides an electrical connection and another part (21) providing an optical connection. A single set of pins (24) connects the connector to its circuit. The connector (20) includes a circuit (26-29) allowing a channel of communication on a motherboard to be connected either electrically or optically. Additionally, a signal may be provided back to the motherboard to indicate which means of connection is employed. A mechanism (21) receives and holds in place optical fibres, and a socket (22) receives an electrical plug. A printed circuit board (26) is fitted with pins (24) to allow connections to be made to a motherboard. The electrical contacts (23) connect the appropriate points on the printed circuit board to the electrical plug, when it is inserted. Opto-electrical components (29) have their leads connected to the printed circuit board (26), so that when optical communication is required the signals can pass through these components. Short pins (28) are mounted on the printed circuit board (26) approximately in-line with some of the contacts (23) and in such a position that the ends of the contacts (23) touch the corresponding pins (28) when there is no electrical plug in the cavity. Other electronic components (27) as required are also mounted on the printed circuit board (26).

### INTRODUCTION

The invention relates to connectors for communication of signals to and from circuit boards.

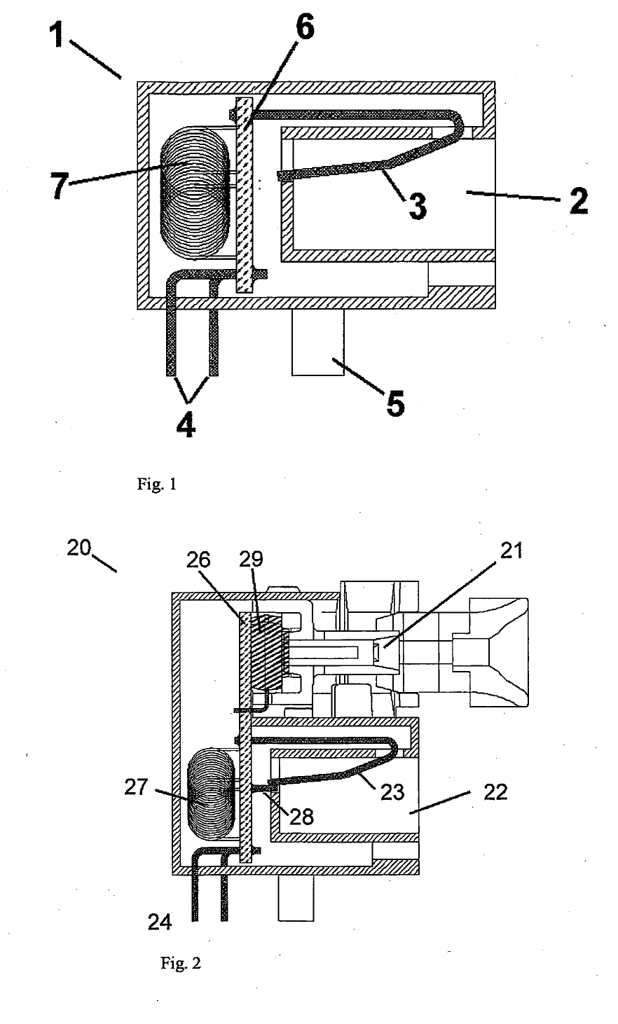

It is well known to provide an electrical socket, adapted for use with an appropriate plug, to allow equipment to be connected to an electrical cable. One common type of socket is the “RJ45” socket, shown in FIG. 1, in which the socket includes a cavity 2 to receive a matching plug. Spring contacts protrude into the cavity, located so that when the plug is inserted they will make electrical contact with corresponding strips of metal in the plug. These spring contacts are connected to pins which protrude from the bottom of the socket to allow electrical connection to the equipment in which the socket is mounted.

It is also known to provide an optical connector, for example that described in our published specification number WO 2007/148315.

The invention is directed towards providing for more versatility in connecting optical and/or electrical signal cables to devices.

### SUMMARY OF THE INVENTION

According to the invention, there is provided a connector comprising:
an electrical socket,
an optical socket, and
a communication channel for transferring signals from the sockets to a host device.

In one embodiment, the communication channel comprises electrical conductors.

In one embodiment, the conductors are in a single backplane or lead.

In one embodiment, the connector further comprises an electro-optical component linked between the optical socket and the communication channel.

In one embodiment, the connector further comprises a switching means to provide a signal on the communication channel indicating which socket is providing data signals.

In one embodiment, the switching means is operated by insertion of an electrical plug into the electrical socket.

In one embodiment, the switching means is operated by insertion of an optical fibre into the optical socket.

In another embodiment, said switching means is adapted to provide either or both of:
a. an external signal fed out of the connector to indicate the presence or absence of said electrical plug or said fibre, and/or
b. switching of signals within the connector.

In one embodiment, the switching means comprises a spring contact element arranged to be in contact with another electrical element inside a socket in the absence of a plug, so that when a plug is inserted the spring contact element is moved to come into contact or to be no longer in contact with said other electrical element.

Preferably, the switching spring contact also serves as a spring contact which can make contact with an appropriate conductive part of a plug when it is inserted.

In one embodiment, the switching means comprises a switch operable by being pressed upon by a part of an inserted plug which does not have an electrical contact.

In one embodiment, said switch is compatible with switches operated by a conductive part of the plug, so that both sets of switches may be formed by substantially the same manufacturing process.

In one embodiment, the connector further comprises a moving element, actuated by the insertion of a plug, which is adapted to move at least one spring contact element so as to break electrical circuit between it and another element within the connector before said spring contact makes electrical contact with any part of said plug.

In one embodiment, the elements are mounted so that relative movement causes wiping of the elements against each other when they are coming into contact.

In one embodiment, an element is a cantilevered spring element, a free end of which slides in a groove within which the other element is located in an offset position.

In one embodiment, the communication channel further comprises circuit elements including capacitors so that the communication channel is connected for AC signals only to electro-optical elements.

In one embodiment, the communication channel further comprises circuit elements including inductors so that electrical contacts for making contact with a plug are isolated from the communication channel.

In one embodiment, a set of external electrical contacts for the communications channel are routed internally to be connected either electrically by means of a plug inserted into a socket in the connector, or optically by means of optical fibres held in proximity to electro-optical devices by an optical socket gripping mechanism.

In another embodiment, the communication channel is adapted to provide signals to a mother board which are identical to those that would be presented by a conventional electrical connector.

In one embodiment, the connector further comprises means to prevent the insertion of an optical fibre if an electrical plug is inserted into the electrical socket, and to prevent insertion of an electrical plug if an optical fibre is present in the optical socket.

In one embodiment, the prevention means comprises a sliding or rotating element which blocks access to one of the sockets at any one time.

In one embodiment, a socket comprises an insert for insertion in another socket.

In one embodiment, the electrical socket also includes electro-optical devices arranged so that, by the insertion of the insert, it may be used for an optical connection.

In one embodiment, the optical socket comprises a pair of fibre sockets each adapted to receive a fibre termination, and each fibre socket comprises a resilient wall facing the other fibre socket and configured so that a clamp pressed between the fibre sockets causes the fibre sockets to grip an inserted fibre.

In one embodiment, the connector further comprises a clamp adapted to be inserted between the fibre sockets to cause them to grip fibres.

In another aspect, the invention provides an insert adapted for use with any socket as defined above.

In one embodiment, the insert comprises an insert body and a clamp, such that movement of the clamp relative to the body of the insert can grip or release optical fibres in the body of the insert.

In one embodiment, the insert comprises a sprung latch to retain it within the socket after it has been inserted.

In one embodiment, the insert includes a lever to release the sprung latch so that it can be removed, if required, from the socket.

### DETAILED DESCRIPTION OF THE INVENTION

The invention will be more clearly understood from the following description of some embodiments thereof given by way of example only with reference to the accompanying drawings in which;

FIG. 1 is a cross sectional view of a prior-art RJ45 socket as described above;

FIG. 2 is a side cross-sectional view of a connector of the invention;

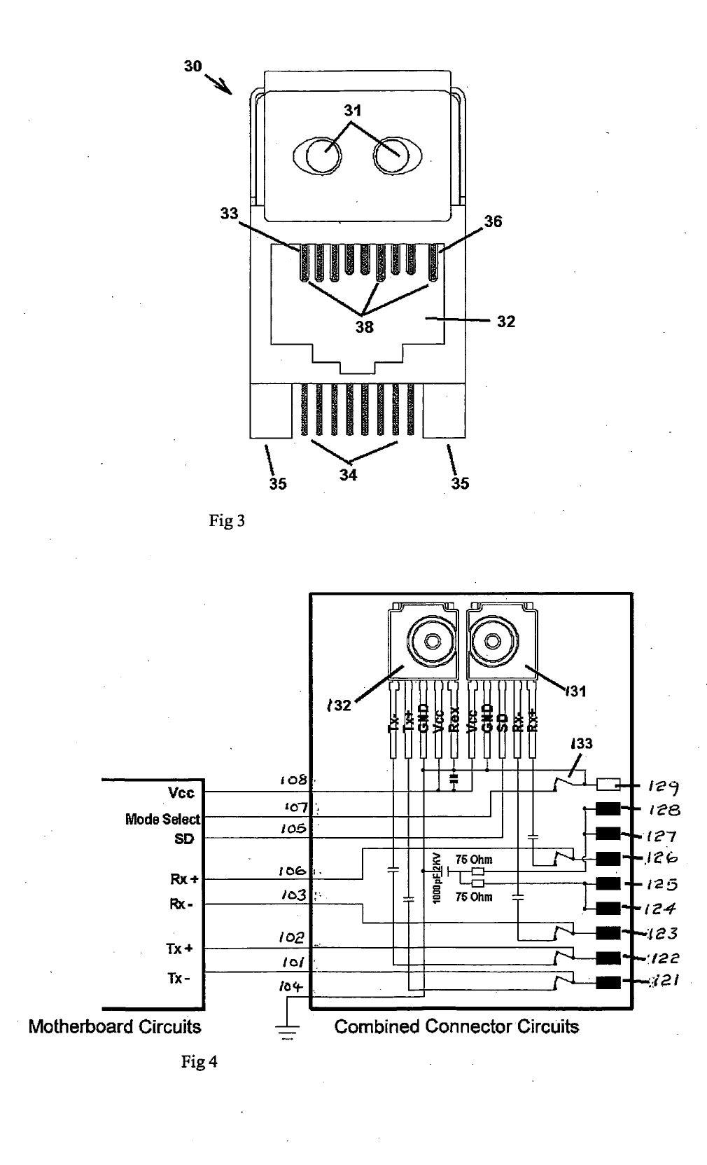

FIG. 3 is a front view of another connector;

FIG. 4 is a circuit diagram of a circuit of the connector;

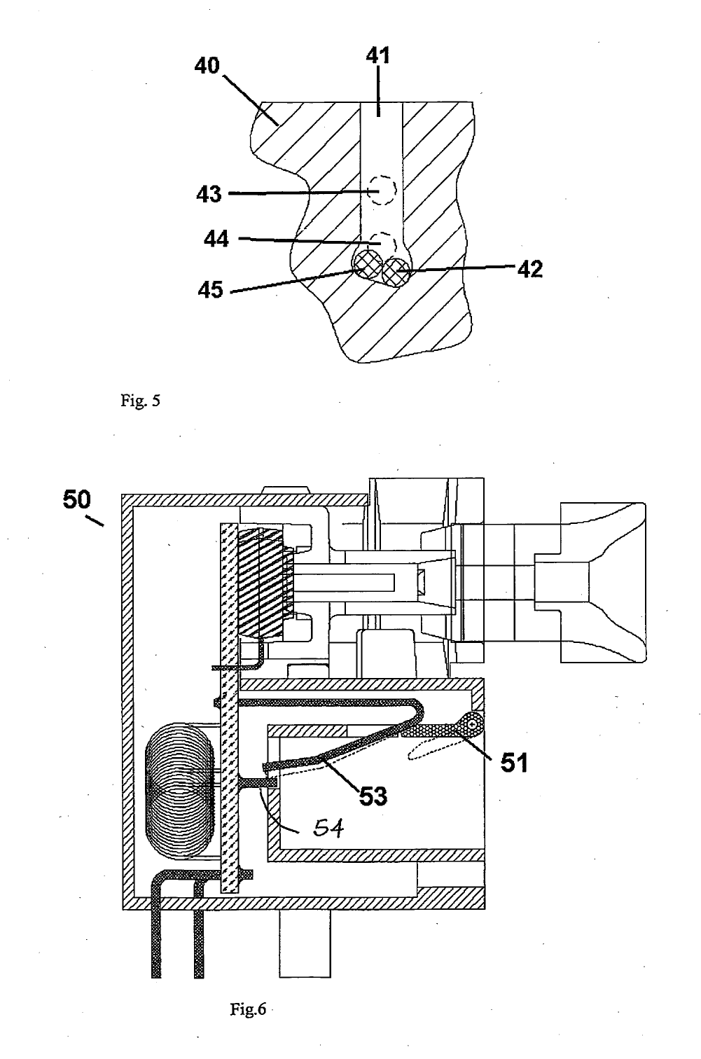

FIG. 5 is a detailed cross-sectional view showing a slot of a back wall of a cavity of the connector;

FIG. 6 is a cross-sectional view of a connector of the invention, incorporating a flap for movement upon insertion of a plug;

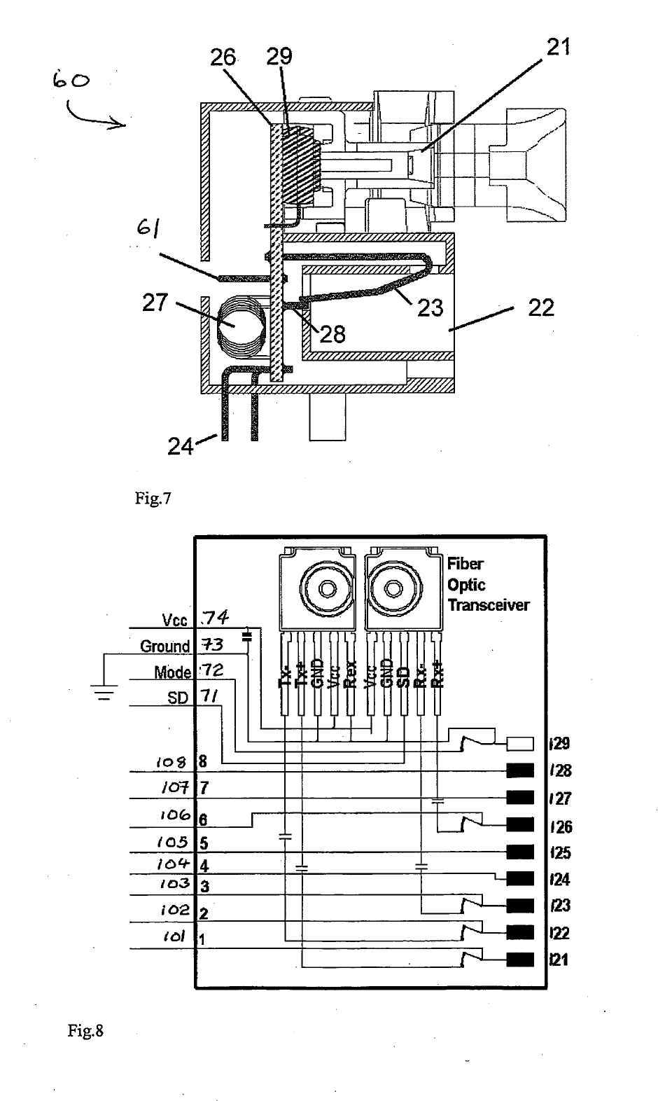

FIG. 7 is a cross-sectional view of a connector of the invention, incorporating an auxiliary connector;

FIG. 8 is a circuit diagram of the connector shown in FIG. 7;

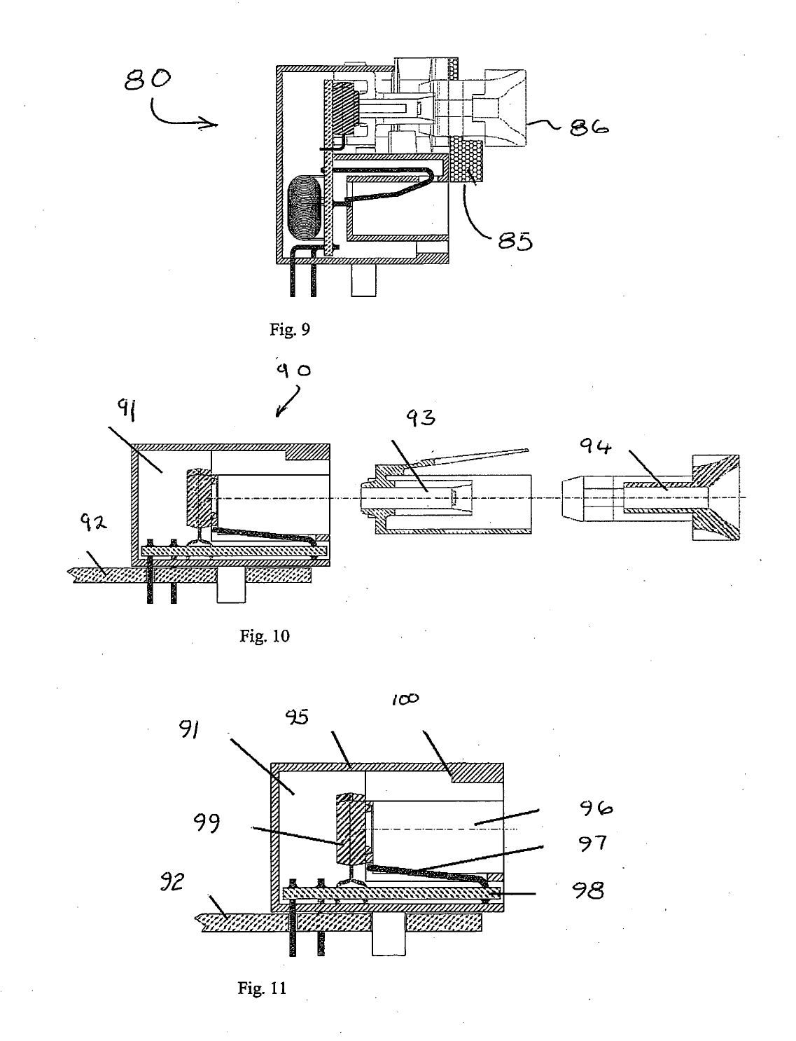

FIGS. 9 to 12 are cross-sectional views of alternative connectors of the invention, and

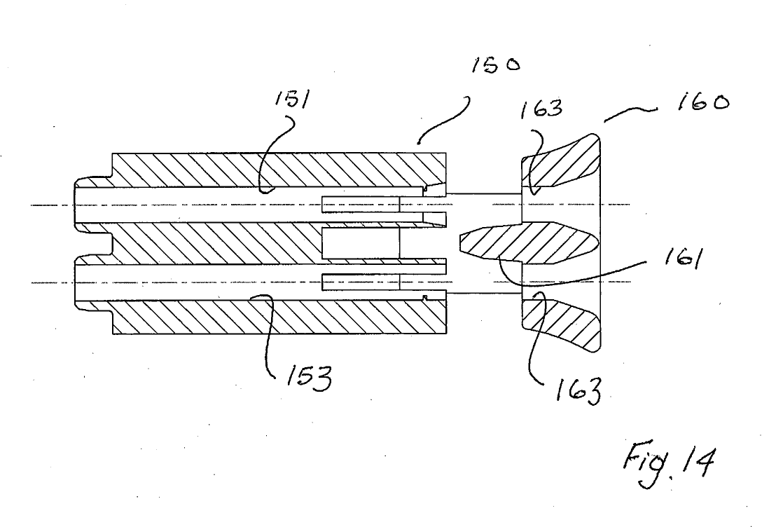

FIGS. 13 and 14 are perspective and cross-sectional plan views showing an alternative optical part of a connector.

A double connector has one part which provides an electrical connection and another part providing an optical connection. A single set of pins connects the connector to its circuit. The connector includes a circuit allowing a channel of communication on a motherboard to be connected either electrically or optically, according as the user of the equipment may choose. Additionally, a signal may be provided back to the motherboard to indicate which means of connection is employed. The double connector may be arranged so that if a (for example, lower cost) piece of equipment is required without an optical interface, then a conventional electrical connector may be fitted in the same place without change to the motherboard.

FIG. 2 shows a simplified cross section through a connector 20 according to the invention, which has a mechanism 21 to receive and hold in place optical fibres, and a socket 22 to receive an electrical plug. A printed circuit board 26 is fitted with pins 24 to allow connections to be made to a motherboard. The electrical contacts 23 connect the appropriate points on the printed circuit board to the electrical plug, when it is inserted. Opto-electrical components 29 have their leads connected to the printed circuit board 26, so that when optical communication is required the signals can pass through these components. Short pins 28 are mounted on the printed circuit board 26 approximately in-line with some of the contacts 23 and in such a position that the ends of the contacts 23 touch the corresponding pins 28 when there is no electrical plug in the cavity. Other electronic components 27 as required are also mounted on the printed circuit board 26.

FIG. 3 shows a front view of a connector 30. In this view the connector 30 includes two holes 31 for the insertion of optical fibres, and a cavity 32 for the insertion of an electrical plug. Within this cavity can be seen a row of eight contact elements 33 which make contact with corresponding portions of the plug when it is inserted. An additional similar element 36 is mounted in a position where there is no corresponding contact on the plug. The tips of the elements 33 and 36 move up and down in slots formed in the back wall of the cavity 32. When there is no plug inserted, some of these contacts rest on the bottoms of the slots in which they move. Others, including the element 36, rest on the tips of short switch pins 38 which are projecting into the back wall from the printed circuit board that is behind this wall. Pins 34, and pegs 35, allow the connector to be mounted on a motherboard in equipment of which it is to form part. The pins 34 connect the electrical signals to the motherboard and the pegs 35 provide mechanical anchorage.

FIG. 4 is a circuit diagram of the connector 30. Pin numbers 101 through 108 are for connection to the motherboard and pin numbers 121 through 128 are for the electrical plug. Pin number 129 identifies a contact-like element mounted to the side of the electrical socket part, where it will make only mechanical contact with the plug. Thus pins 101 to 108 in FIG. 4 correspond to pins 34 in FIG. 3, pins 121 to 128 in FIG. 4 correspond to pins 33 in FIG. 3, and pin 129 in FIG. 4 corresponds to pin 36 in FIG. 3.

In FIG. 4, item 131 identifies an opto-electrical receiver assembly, and number 132 identifies the opto-electrical transmitter assembly. The five switches 133 are formed by the tips of the corresponding contact or contact-like elements touching the corresponding pins projecting from the printed circuit board. In the diagram they are shown in their closed positions, i.e. when there is no plug in the cavity. The six capacitors and two resistors shown in the circuit diagram are mounted on the printed circuit board within the connector. It can be seen that the main communication circuits Tx+, Tx−, Rx+ and Rx− are connected to the appropriate pins of the opto-electrical subassemblies when the electrical plug is not present, and are connected to the electrical plug and not to the optical elements as soon as the plug is inserted. The pin 107 is connected to ground when the plug is absent, and is disconnected when the plug is inserted, so providing a signal back to the circuits mounted on the motherboard to indicate which type of connection is in use.

FIG. 5 shows in more detail a part 40 of the back wall of the cavity 32 shown in FIG. 3 provided for the electrical plug. One of a number of slots 41 is shown. At the bottom of the slot, slightly offset from the axis of the slot, is a switch pin 42. When released by the removal of the electrical plug, the tip of the contact moves down the slot through positions 43 and 44 until coming to rest in position 45. The sliding action of the contact moving around the pin from position 44 to position 45 will provide a wiping action, so cleaning the surfaces of both components and promoting good electrical contact.

With the arrangement as shown in FIG. 2, during the insertion of the plug, there could be a momentary electrical connection between the electrical contact of the plug and the contact element 23 while the contact element 23 was still in contact with the switch pin 28. This would occur when first contact was made between the plug and the contact, and before the contact was lifted sufficiently to open the switch. If this momentary contact is to be avoided, a mechanical flap 51 can be fitted as shown in FIG. 6. In this drawing the combined connector 50 is generally as already described, but there is additionally the flap 51 pivoted within the housing of the connector. As shown by the dotted lines, when there is no plug in the cavity, the flap 51 can move away from the electrical contact 53, and allow the electrical contact 53 to rest on, and make electrical contact with, the switch pin 54. When the plug is inserted a small distance into the cavity, the flap 51 is forced into the position shown by the solid lines, and lifts the contact 53 to the position shown by solid lines, so that the electrical circuit between the contact 53 and the switch pin 54 is broken before the plug can make an electrical circuit with the contact 53.

FIG. 7 is a cross sectional view through a connector 60, similar to that shown in FIG. 2 and like parts are assigned the same reference numerals. The connector 60 has an additional auxiliary connector 61. In this embodiment, as in FIG. 2, there is a mechanism 21 to receive and hold in place optical fibres and a socket 22 to receive an electrical plug. A printed circuit board 26 is fitted with pins 24 to allow connections to be made to a motherboard. The electrical contacts 23 connect the appropriate points on the printed circuit board to the electrical plug, when it is inserted. The opto-electrical components 29 have their leads connected to the printed circuit board 26, so that when optical communication is required the signals can pass through these components. Short switch pins 28 are mounted on the printed circuit board 26 and project through the back wall of the cavity 22 approximately in-line with some of the contacts 23. As described with reference to FIG. 5, these are positioned so that the ends of the contacts touch the corresponding pins 28 when there is no electrical plug in the cavity. Other electronic components 27 as required are also mounted on the printed circuit board 26. In addition, a set of pins 61 form an auxiliary connector. With this arrangement the pins 24 can all have the same printed circuit board connections as would be the case if an electrical connector only were to be fitted, and the additional connections required for the combined connector (for example, a power supply for the optical components) can be made by a cable within the equipment connected to the auxiliary connector.

FIG. 8 is circuit diagram of the connector shown in FIG. 7. Numbers 101 through 108 refer to the eight pins provided for connection to the motherboard. Numbers 121 through 128 refer to the eight contacts for the electrical plug. Number 129 identifies the contact-like element mounted to the side of the electrical socket part, where it will make only mechanical contact with the plug. Numbers 71 to 74 identify additional pins provided on the auxiliary connector 61. It can be seen that the main communication circuits Tx+, Tx−, Rx+ and Rx− are connected to the appropriate pins of the opto-electrical sub-assemblies when the electrical plug is not present, and are connected to the electrical plug and not to the optical elements as soon as the plug is inserted. Pins 104, 105, 107 and 108 are connected to the pins 124, 125, 127 and 128 as would be the case in a simple electrical connector. A power supply for the connector is provided by means of the pins 73 and 74 on the auxiliary connector 61, and the signals identified as “Mode” and “SD” are available on this connector if they are required to be connected within the equipment.

Referring to FIG. 9, a connector 80 has an element 85, which is a slider to prevent an optical fibre from being inserted while an electrical plug is still in place and vice-versa. When the slider 85 is in an upper position as shown, a clamp 86 for holding the fibre in place cannot be closed, and elements of the sliding portion can pass between the passages in the clamp and the passages in the rest of the optical part of the connector, to prevent a fibre from being inserted (conversely, the slider cannot be lifted into the position shown if a fibre has already been inserted). If the sliding portion 85 is moved down, then it blocks the entrance to the electrical part of the connector, so that a plug cannot be inserted (and, again, the slider 85 cannot be moved down if a plug is already in position). Instead of the sliding mechanism shown, the same purpose could be accomplished by a rotating element within the connector, so shaped and pivoted that in one position a part of it projects into the cavity to prevent the electrical plug being inserted, and in the other position a part of it projects into the path of the optical fibre. If neither fibre nor plug were present, the slider would be free to move, and could be moved out of the way by the insertion of either fibre or plug. However, once one is inserted, it would have to be removed before the other could be inserted.

Another embodiment is shown in FIG. 10, in which a connector system 90 comprises a socket 91, an insert 93 and a clamp 94. The connector 91 is shown here mounted on a motherboard 92 of a piece of equipment of which it forms part.

The socket 91 is shown in more detail in FIG. 11, in which it can be seen to include a housing 95, in which there is formed a cavity 96. Electrical contacts 97 project into this cavity. These electrical contacts are attached to a printed circuit board 98 internal to the socket. Within the housing 95 there are one or more electro-optical devices 99: These are electrically connected to the internal printed circuit board 98 and are mounted close to the back of the cavity 96. Holes in the back wall of the cavity permit access to the optical portions of these devices from the cavity. The printed circuit board 98 carries the necessary circuits to connect the electrical contacts and the electro-optical devices to the motherboard 92 of the equipment in which the socket is mounted. An internal step 100 within the cavity provides a location for a latch mechanism to retain a plug or insert within the socket.

If electrical connection is desired, it will be appreciated that the cavity 96 and the electrical contacts 97 allow this socket to function as a normal electrical socket, receiving a plug (not shown) and making an electrical connection in the usual way.

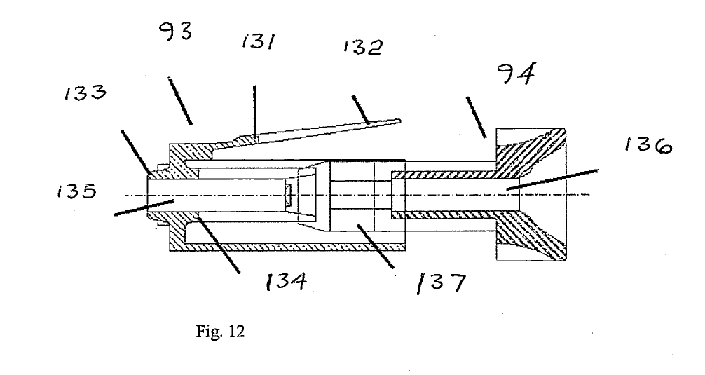

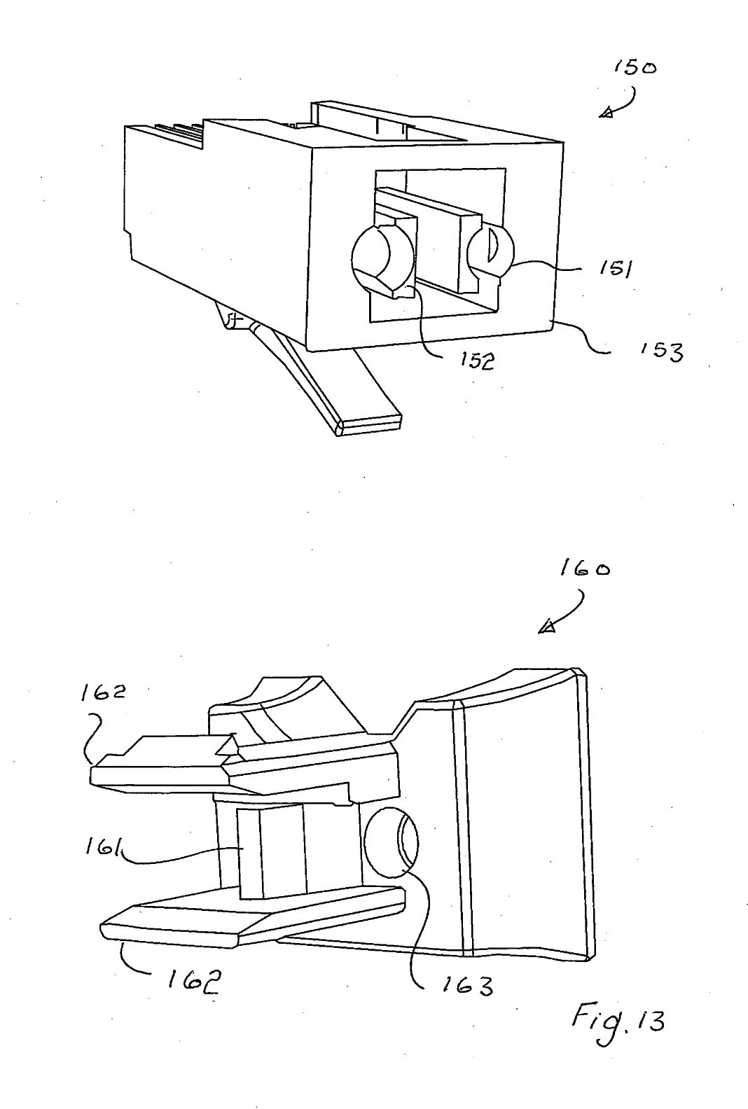

If, on the other hand, an optical connection is required, the insert 93, assembled with the clamp 94, may be inserted into the socket 91 to adapt it for optical connections. FIG. 12 shows the insert 93 and the clamp 94 assembled together. The insert 93 may be moulded as a single piece, adapted in shape for fitting into the cavity 96 of the socket. The insert includes a latch 131 adapted to engage in the internal step 100 of the socket cavity. A lever 132 allows this latch to be disengaged if it is desired to remove the insert from the socket. The front end of the insert has features 133 designed to align the insert accurately with the electro-optical devices 99, either by engaging directly with features on the electro-optical devices, or by engaging with features on the back wall of the cavity, in which case the back wall of the cavity should also have features to align it accurately with the electro-optical devices. The insert also includes one or more broadly cylindrical features 134, which are split lengthwise over part of their length. These cylindrical features carry a cylindrical passage 135, suitable to guide an optical fibre, or an optical fibre surrounded by a cylindrical jacket. The alignment features 133 and the passage 135 are so arranged that a fibre introduced through the passage will be aligned with the optical axis of the electro-optical device 99.

The clamp 94 also includes one or more cylindrical passages 136 suitable for guiding an optical fibre, so that a fibre may be introduced into the clamp and passed through it into the passage 135 in the insert 93. The clamp 94 also includes elements 137, which may be tapered or wedge shaped over part of all of their length, and which are adapted to slide beside or between the cylindrical portions 134 of the clamp. After it has been assembled with the insert, the clamp is still capable of movement within the insert along the axis of the cavities, 135 and 136. The insert and clamp include guiding surfaces (not shown in detail) to keep the axis of the clamp aligned with the axis of the insert, and a catch mechanism (not shown) to limit the movement of the clamp so that it cannot easily be removed from the insert after they have been assembled together. When the clamp is moved further into the insert, the elements 137 serve to squeeze the cylindrical features 134 of the insert in the area in which they are split, so as to squeeze the two sides together, and grip the optical fibre which has been inserted.

Thus to make an optical connection to the socket, the user may insert the insert-clamp assembly into the socket until it is correctly located and retained in position by the latch; They then ensure that the clamp is in its open position, where it is not squeezing the cylindrical elements of the insert. They then insert one or more optical fibres through the passages in the clamp, which passages guide the fibres into the passages in the insert. The user keeps inserting the fibres until they make contact with the electro-optical elements. Then the user pushes in the clamp, so squeezing the cylindrical portions of the insert to grip the fibre and retain it in place.

To remove the optical connection, the user has two choices: They may pull back the clamp without removing it from the insert, so releasing the fibre, but leaving the insert in the socket; or they may release the insert from the socket by operating the lever 132, and remove the insert, complete with the clamp and the optical fibre, from the socket.

Referring to FIGS. 13 and 14 the optical part of the connector may comprise a housing 150 having two sockets 151 and 152 in a moulded plastics frame 153 for receiving optical fibres. A clamp 160 has a central clamp member 161 which slides between the two sockets 151 and 152 to cause them to press against a fibre due to a wedging effect. The clamp 13 has through holes 163 for receiving the fibres, and snap-fitting lugs 164.

The invention is not limited to the embodiments described but may be varied in construction and detail.

1-29. (canceled)

30. A connector comprising:
an electrical socket,
an optical socket, and
a communication channel for transferring signals from the sockets to a host device,
wherein the communication channel comprises electrical conductors,
wherein the connector further comprises a switching means, and said switching means is adapted to provide either or both of:
a. an external signal fed out of the connector on said communication channel to indicate the presence or absence of said electrical plug or said fibre, and/or
b. switching of signals within the connector.
wherein the optical socket comprises an insert for insertion in the electrical socket, and
wherein the electrical socket also includes electro-optical devices arranged so that, by the insertion of the insert, it may be used for an optical connection.

31. The connector as claimed in claim 30, wherein the switching means is operated by insertion of an electrical plug into the electrical socket.

32. The connector as claimed in claim 30, wherein the switching means comprises a spring contact element arranged to be in contact with another electrical element inside a socket in the absence of a plug, so that when a plug is inserted the spring contact element is moved to come into contact or to be no longer in contact with said other electrical element.

33. The connector as claimed in claim 30, wherein the switching means comprises a spring contact element arranged to be in contact with another electrical element inside a socket in the absence of a plug, so that when a plug is inserted the spring contact element is moved to come into contact or to be no longer in contact with said other electrical element; and wherein the switching spring contact also serves as a spring contact which can make contact with an appropriate conductive part of an electrical plug when it is inserted.

34. The connector as claimed in claim 30, wherein the switching means comprises a switch operable by being pressed upon by a part of an inserted plug which does not have an electrical contact.

35. The connector as claimed in claim 30, wherein the switching means comprises a switch operable by being pressed upon by a part of an inserted plug which does not have an electrical contact; and wherein said switch is compatible with switches operated by a conductive part of the plug, so that both sets of switches may be formed by substantially the same manufacturing process.

36. The connecter as claimed in claim 30, comprising a moving element, actuated by the insertion of a plug, which is adapted to move at least one spring contact element so as to break electrical circuit between it and another element within the connector before said spring contact makes electrical contact with any part of said plug.

37. The connector as claimed in claim 30, wherein the elements are mounted so that relative movement causes wiping of the elements against each other when they are coming into contact, and wherein an element is a cantilevered spring element, a free end of which slides in a groove within which the other element is located in an offset position.

38. The connector as claimed in claim 30, wherein the communication channel further comprises circuit elements including capacitors so that the communication channel is connected for AC signals only to electro-optical elements, and wherein the communication channel further comprises circuit elements including inductors so that electrical contacts for making contact with a plug are isolated from the communication channel.

39. The connector as claimed in claim 30, wherein the communication channel further comprises circuit elements including capacitors so that the communication channel is connected for AC signals only to electro-optical elements, and wherein the communication channel further comprises circuit elements including inductors so that electrical contacts for making contact with a plug are isolated from the communication channel; and wherein a set of external electrical contacts for the communications channel are routed internally to be connected either electrically by means of a plug inserted into a socket in the connector, or optically by means of optical fibres held in proximity to electro-optical devices by an optical socket gripping mechanism.

40. The connector as claimed in claim 30, in which the communication channel is adapted to provide signals to a mother board which are identical to those that would be presented by a conventional electrical connector.

41. The connector as claimed in claim 30, wherein the optical socket comprises a pair of fibre sockets each adapted to receive a fibre termination, and each fibre socket comprises a resilient wall facing the other fibre socket and configured so that a clamp pressed between the fibre sockets causes the fibre sockets to grip an inserted fibre, and wherein the connector further comprises a clamp adapted to be inserted between the fibre sockets to cause them to grip fibres.

42. An insert adapted for use with a socket as claimed in claim 30.

43. The insert as claimed in claim 42, comprising an insert body and a clamp, such that movement of the clamp relative to the body of the insert can grip or release optical fibres in the body of the insert, and including a sprung latch to retain it within the socket after it has been inserted.
